(19) United States
(12) Patent Application Publication
(10) Pub. No.: US 2021/0051129 A1
(43) Pub. Date: Feb. 18, 2021

(54) Method and Apparatus for Making Friends via Face Recognition

(71) Applicant: Xuezhi Zhang, Guangzhou (CN)

(72) Inventor: Xuezhi Zhang, Guangzhou (CN)

(21) Appl. No.: 16/660,841

(22) Filed: Oct. 23, 2019

(30) Foreign Application Priority Data
Aug. 15, 2019 (CN) 201910755907.1

(51) Int. Cl. H04L 12/58; G06K 9/00; H04L 29/08; G06Q 50/00; G06F 16/53

(52) U.S. Cl. CPC H04L 51/32; G06K 9/00255; H04L 67/10; G06F 3/04883; G06Q 50/01; G06F 16/53; H04L 67/306

(57) ABSTRACT

The present invention discloses a method and apparatus for making friends via face recognition, in which one can see the real person and get interested from the very beginning and then start to make contact with the interested person, more close to the natural process of making social acquaintance, avoiding blindness in social networking and reducing the incidence of cheating and fraud events in social networking; meanwhile the method avoids the embarrassment of directly requesting for telephone numbers when meeting with desired candidates for friends.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention is related to the information system for social networking.

There exists blindness in social networking currently on the internet because virtual friends do not meet with each other face to face, often leading to cheating and fraud events in social networking. The present invention put forth a method for making friends via face recognition, in which one can see the real person and get interested from the very beginning and then start to make contact with the interested person, more close to the natural process of making social acquaintance, avoiding blindness in social networking and reducing the incidence of cheating and fraud events in social networking. Meanwhile the method avoids the embarrassment of directly requesting for telephone numbers when meeting with desired candidates for friends.

### BRIEF SUMMARY OF THE INVENTION

The present invention put forth a method and apparatus for making friends via face recognition, in which one can see the real person and get interested from the very beginning and then start to make contact with the interested person, more close to the natural process of making social acquaintance, avoiding blindness in social networking and reducing the incidence of cheating and fraud events in social networking.

The method for the present invention can be realized by social networking Apps on smart phones and other smart devices. When users open the social networking App, they can invoke the friend scanning function to activate the camera, aim at the interested candidate for friend, and select the candidate by touching the candidate's face image to dispatch out the command of making friends. The command with a face image of the candidate is sent to the server for the App, the server program for the App starts to search in its database for the account of the candidate by face recognition; if the candidate's account is found, the program send a request for making friends to the found account, together with the user's true face image or photo and a brief remark; if the candidate's account is not found, a short message stating that the candidate's account cannot be found is displayed to the user. After the candidate receives the request for making friends, the candidate can accept the request to become friends with the user or decline according to the situations.

In another embodiment of the present invention, when users open the social networking App, invoke the friend scanning function to activate the camera, aim at the interested candidate for friend, and select the candidate by touching the candidate's face image to dispatch out the command of making friends, the candidate's photo or face image is sent to the server program of the App together with the command, the back end server program searches via face recognition the database of the App, the databases of cooperating social networking platforms and/or public face images databases to obtain incomplete information of the candidate, including the candidate's account in the App, the candidate's accounts in cooperating social network platforms such as QQ number, WeChat ID, TikTok ID and Facebook ID etc., and the candidate's mobile phone numbers. The incomplete information is displayed to the user for the user to select the desired account to make contact with, a request is then sent to the candidates selected account. If the candidate's accounts cannot be found in all the databases, a short message stating that the candidate's account cannot be found is displayed to the user.

### DETAILED DESCRIPTION OF THE INVENTION

The method for the present invention can be realized by social networking Apps on smart phones and other smart devices. When users open the social networking App, they can invoke the friend scanning function to activate the camera, aim at the interested candidate for friends, and select the candidate by touching the candidate's face image to dispatch out the command of making friends with the candidate. The command with a short video clip or a photo or a face image of the candidate is sent to the server for the App, the server program for the App starts to search in its database for the account of the candidate through face recognition; if the candidate's account is found, the program send a request for making friends to the found account, together with the user's true face image or photo and a brief remark, the remark can be standard greetings or can be input by the user; if the candidate's account is not found, a short message stating that the candidate's account cannot be found is displayed to the user. Users must take real photos of themselves and upload to the server when they create accounts in the App; after the account is created, users can replace the uploaded photo with a desired photo or face image of themselves, the App will verify the photo or face image by face recognition with the originally taken and uploaded photo in the server program. After the candidate receives the request for making friends, the candidate can accept the request to become friends with the user or decline according to the situations.

In another embodiment of the present invention, the App does not require users to take photos of themselves when creating account. When users open the social networking App, invoke the friend scanning function to activate the camera, aim at the interested candidate for friend, and select the candidate by touching the candidate's face image to dispatch out the command of making friends with the candidate, the candidate's photo or face image is sent to the server program of the App together with the command, the back end server program searches via face recognition algorithms the database of the App, the databases of cooperating social networking platforms and/or public face images databases to obtain incomplete information of the candidate, including the candidate's account in the App, the candidate's accounts in cooperating social network platforms such as QQ number, WeChat ID, TikTok ID and Facebook ID etc., and the candidate's mobile phone numbers. The search result information is displayed to the user for the user to select the desired account to make contact with, if the selected account is an account from a cooperating social networking platform, the user is also required to enter his/her own account ID in the cooperating social network platform, meanwhile the user can select weather to take a photo of himself/herself or attach a verified photo or face image of himself/herself to be sent out together with the request for making friends with the candidate, the request is then sent to the candidate's selected account. If the candidate's accounts cannot be found in all the databases, a short message stating that the candidate's account cannot be found is displayed to the user. After the candidate receives the request for making friends, the candidate can accept the request to become friends with the user or decline according to the situations.

In one embodiment of the present invention, if two users using the App invoke the friend scanning function to activate the camera at the same time and aim at each other and touch each other's face image within a short period of time (say 10 seconds) to activate the fried making command, then they make friends successfully and the two users are directly set to be friends.

The apparatus or system for realizing the method of making friends via face recognition includes smart phones or Pads or computers or other smart devices with a camera which can run Apps, and a server which can be a cloud computing server or a normal server, the server runs the server program for the App, which includes a face recognition module, and stores the user database and image database for real photos or face images of users. The server can also be connected to access the databases of cooperating social network platforms or public face image databases. The smart phones and other smart devices can communicate with the server through 5G or other wireless communication technology.

The above technical schemes include the preferred technical scheme of the present invention, but the present invention also covers various variants of the above technical schemes according to the innovative thoughts, ideas or concepts of the present invention, e.g. users can select to take a photo of themselves to provide a real photo or face image of themselves when creating accounts, and afterwards they can replace the real photo in their accounts by selecting a better or desired picture or face image of themselves, the backend program will verify the picture or face image by face recognition using the original real photo; users can also select not to take a photo of themselves when creating accounts, but select to take a photo of themselves when invoking command of making friends and attach the photo to the command and save the photo to his/her account; users can also select not to send photos or face images of themselves together with command for making friends. The system described above can be a cloud computing system (App/Server or A/S system) with a cloud computing server or it can be a B/S (Browser/Server) system or a C/S (Client/Server) system; etc.

The present invention put forth a method for making friends via face recognition, in which one can see the real person and get interested from the very beginning and then start to make contact with the candidate for friends, more close to the natural process of making social acquaintance, avoiding blindness in social networking and reducing the incidence of cheating and fraud events in social networking. Meanwhile the method avoids the embarrassment of directly requesting for telephone numbers when meeting with desired candidates for friends.

### Detailed Embodiment

Further description of the present invention is made in the following section with two preferred embodiments.

Preferred Embodiment One: The method for the present invention can be realized by social networking Apps on smart phones and other smart devices. When users open the social networking App, they can invoke the friend scanning function to activate the camera, aim at the interested candidate for friends, and select the candidate by touching the candidate's face image to dispatch out the command of making friends with the candidate. The command with a short video clip or a photo or a face image of the candidate is sent to the server for the App, the server program for the App starts to search in its database for the account of the candidate through face recognition; if the candidate's account is found, the program send a request for making friends with the candidate to the found account, together with the user's true face image or photo and a brief remark, the remark can be standard greetings or can be input by the user; if the candidate's account is not found, a short message stating that the candidate's account cannot be found is displayed to the user.

In this embodiment, users must take real photos of themselves and upload to the server when they create accounts in the App; after the account is created, users can replace the uploaded photo with a desired photo or face image of themselves, the App will verify the photo or face image by face recognition with the originally taken and uploaded photo in the server program. After the candidate receives the request for making friends, the candidate can accept the request to become friends with the user or decline according to the situations.

In this embodiment, if two users using the App invoke the friend scanning function to activate the camera at the same time and aim at each other and touch each other's face image within a short period of time (say 10 seconds) to activate the fried making command, then they make friends successfully and the two users are directly set to be friends.

Preferred Embodiment Two: In this embodiment of the present invention, the App does not require users to take photos of themselves when creating account. When users open the social networking App, invoke the friend scanning function to activate the camera, aim at the interested candidate for friends, and select the candidate by touching the candidate's face image to dispatch out the command of making friends with the candidate, the candidate's photo or face image is sent to the server program of the App together with the command, the back end server program searches through face recognition algorithms the database of the App, the databases of cooperating social networking platforms and/or public face images databases to obtain incomplete information of the candidate, including the candidate's account in the App, the candidate's accounts in cooperating social network platforms such as QQ number, WeChat ID, TikTok ID and Facebook ID etc., and the candidate's mobile phone numbers. The search result information is displayed to the user for the user to select the desired account to make contact with, if the selected account is an account from a cooperating social networking platform, the user is also required to enter his/her own account ID in the cooperating social network platform, meanwhile the user can select weather to take a photo of himself/herself or attach a verified photo or face image of himself/herself to be sent out together with the request for making friends with the candidate, the request is then sent to the candidate's selected account. If the candidate's accounts cannot be found in all the databases, a short message stating that the candidate's account cannot be found is displayed to the user. After the candidate receives the request for making friends, the candidate can accept the request to become friends with the user or decline according to the situations.

The present invention can be employed in any general purpose or special purpose computing environments or computing systems. Examples of applicable known computing systems, computing environments and/or computing configurations for the present invention include, but not limited to, personal computer, server computer, special purpose computers, portable or laptop equipment, handsets, multiple processor systems, systems based on micro-processors, set top box, programmable consumer electronic appliances, network personal computers, small computers, large scale computers, cloud computing systems (A/S: App/Server), B/S systems, C/S systems and distributed computing environments which contain any systems and/or equipments described above, etc.

The embodiments above are examples provided for general technicians in the field to realize the present invention. Technicians in the field can make changes or modifications to the embodiments described above in accordance with the creative thoughts of the present invention. Therefore the scope of the present invention will not be limited by the above embodiments, but will be extended to the maximum extent in accordance with the creative characteristics put forward in the claims section. The present invention claims all the claims presented in the Claims section.

1. A method for making friends through face recognition, comprising:
Users invoke a friend scanning function to activate a camera in a smart phone or smart device, aim at an interested candidate for friends, and select the candidate to dispatch out a command of making friends with the candidate in an App;
the candidate's photo or face image is sent to a server program of the App together with the command, the server program searches through face recognition one or several of the database of the App, databases of cooperating social networking platforms and public face image databases to obtain an account or accounts of the candidate, to which request for making friends is sent;
if the candidate's account cannot be found, a message stating that the candidate's account cannot be found is displayed to the user.

2. The method for making friends of claim 1, wherein the server program can also be connected to access the databases of cooperating social network platforms or public face image databases to search for the candidate's accounts.

3. The method for making friends of claim 1, wherein the ways for selecting the candidate and invoking the command of making friends include usual selection and command invoking actions or gestures including touching the face image of the candidate etc.; the selection of candidate and activation of the command for making friends with the candidate can be directly completed with usual selection and/or command invoking actions or gestures including touching the candidate's face image etc.; the selection of candidate can also be conducted by usual selection actions or gestures including touching the candidate's face image etc., and then the command for making friends with the candidate can be invoked by usual command invoking actions or gestures including touching the picture or the “Request to Make Friends” command etc.

4. The method for making friends of claim 1, wherein a user can select whether to attach a real photo or face image of the user and a message for the friend candidate to browse when invoking the command for making friends with the candidate; if there is still no real photo or face image of the user in his/her account, the user is asked whether to take a photo or face image of himself/herself, the taken photo or face image is then saved to his/her account, the user can replace the taken photo or face image with a desired photo or face image of himself/herself, the server program will start a face recognition algorithm to verify the authenticity of the provided photo or face image.

5. The method for making friends of claim 1, wherein the search result accounts for the friend candidate are displayed to the user for him/her to select an account to send request for making friends when one or several accounts with different social networking Apps are found for the friend candidate, if the selected account is with a cooperating social networking platform, then the user also needs to enter his/her account with the same social networking platform.

6. The method for making friends of claim 1, wherein two users are directly set to be friends if the two users invoke the friend scanning function to activate the camera, aim at each other and select each other within a short period of time like 1-10 seconds to activate the friend making command.

7. A system for making friends through face recognition, comprising:
Users invoke a friend scanning function to activate a camera in a smart phone or smart device, aim at an interested candidate for friends, and select the candidate to dispatch out a command of making friends with the candidate in an App;
the candidate's photo or face image is sent to a server of the App together with the command, the server searches through face recognition one or several of the database of the App with real photos or face images of users, databases of cooperating social networking platforms and public face image databases to obtain an account or accounts of the candidate, to which request for making friends is sent;
if the candidate's account cannot be found, a message stating that the candidate's account cannot be found is displayed to the user.
the smart phones and other smart devices can communicate with the server through 5G or other wireless communication technology.

8. The system of claim 7, wherein the server can also be connected to access databases of cooperating social network platforms or public face image databases to search for the accounts of a friend candidate.

9. The system of claim 7, wherein the ways for selecting the candidate and invoking the command of making friends include usual selection and command invoking actions or gestures including touching the face image of the candidate etc.; the selection of candidate and activation of the command for making friends with the candidate can be directly completed with usual selection and/or command invoking actions or gestures including touching the candidate's face image etc.; the selection of candidate can also be conducted by usual selection actions or gestures including touching the candidate's face image etc., and then the command for making friends with the candidate can be invoked by usual command invoking actions or gestures including touching the picture or the “Request to Make Friends” command etc.

10. The system of claim 7, wherein a user can select whether to attach a real photo or face image of the user and a message for the friend candidate to browse when invoking the command for making friends with the candidate; if there is still no real photo or face image of the user in his/her account, the user is asked whether to take a photo or face image of himself/herself, the taken photo or face image is then saved to his/her account, the user can replace the taken photo or face image with a desired photo or face image of himself/herself, the server program will start a face recognition algorithm to verify the authenticity of the provided photo or face image.

11. The system of claim 7, wherein the search result accounts for the friend candidate are displayed to the user for him/her to select an account to send request for making friends when one or several accounts with different social networking Apps are found for the friend candidate, if the selected account is with a cooperating social networking platform, then the user also needs to enter his/her account with the same social networking platform.

12. The system of claim 7, wherein two users are directly set to be friends if the two users invoke the friend scanning function to activate the camera, aim at each other and select each other within a short period of time like 1-10 seconds to activate the friend making command.
